(19) United States
(12) Patent Application Publication
(10) Pub. No.: US 2026/0072736 A1
(43) Pub. Date: Mar. 12, 2026

(54) RATE LIMITING FOR ACCELERATORS

(71) Applicant: Intel Corporation, Santa Clara, CA (US)

(72) Inventors: Swarna PUNDIR, Limerick (IE); Gavin TROY, Shannon (IE)

(21) Appl. No.: 19/387,067

(22) Filed: Nov. 12, 2025

(51) Int. Cl. G06F 9/48

(52) U.S. Cl. CPC G06F 9/4881

(57) ABSTRACT

Examples described herein relate to adjusting a queue size based on utilization of a device and an artificial intelligence (AI) model trained on at least one or more of: data size, request priority, device congestion, device latency, device interface throughput, network throughput, queue length, queue priority, request receipt rate, number of queues allocated to receive the requests, device memory usage, and/or whether address translation prefetch mode is enabled or not enabled. In some examples, the device includes an accelerator to perform cryptographic and/or compression operations in response to the requests.

A processor can offload cryptographic and compression tasks to accelerator devices to reduce computational loads on the processor. Rate limiting is utilized to avoid overloading of an accelerator device by requests to perform operations to avoid slowing down operations of the accelerator device and to meet customer Service Level Agreements (SLA).

### BRIEF DESCRIPTION OF THE DRAWINGS

FIG. 1 depicts an example system.

FIG. 2 depicts an example system.

FIG. 3 depicts an example accelerator.

FIG. 4 shows an example process.

FIG. 5 depicts a system.

### DETAILED DESCRIPTION

Various examples can adjust allocation of requests among queues to an accelerator device based on utilization of the accelerator and an artificial intelligence (AI) model trained on at least one or more of: device congestion, device latency, device interface or network throughput, queue length, queue priority, request receipt rate, number of queues allocated to receive the requests, device memory usage, and/or whether address translation prefetch mode is enabled or not enabled. In some examples, a middleware interface from a process to a driver for the device can perform the allocating requests to queues for inputting the requests for performance by the accelerator device. In some examples, the accelerator device can perform cryptographic and/or compression operations on data associated with the requests. Various examples can dynamically adjust processing rate limits for requests from a queue and move requests among queues or dynamically allocate resources of the accelerator device (e.g., frequency, power, memory allocation, cache allocation, device interface bandwidth, network interface bandwidth, or others) and prioritize performance of requests based on accelerator device load and service requirements.

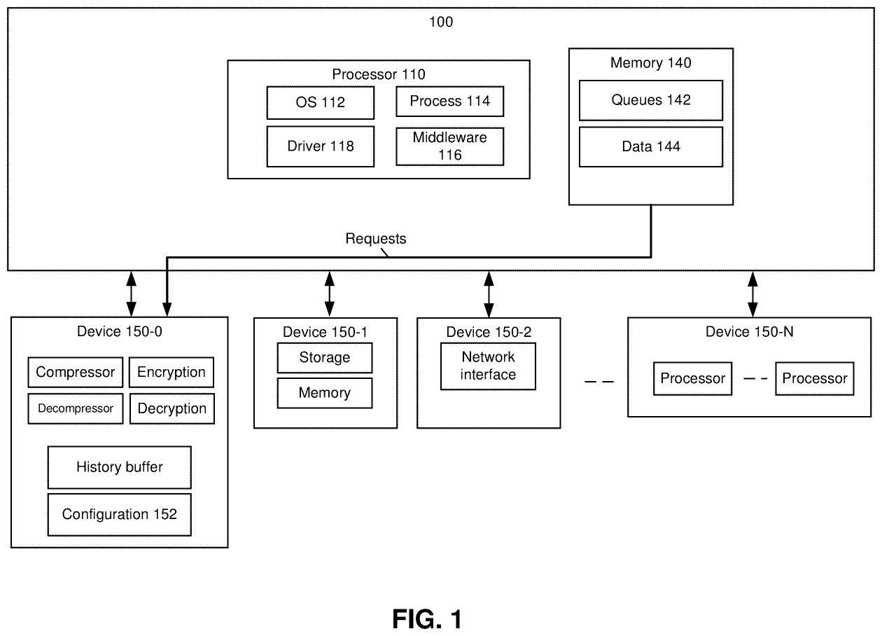

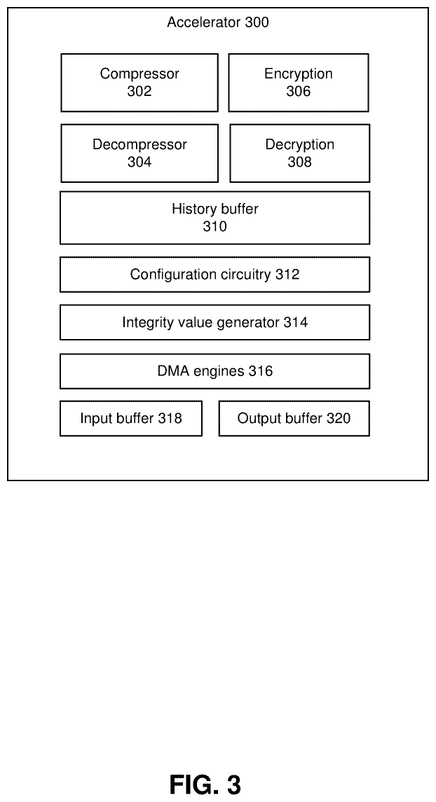

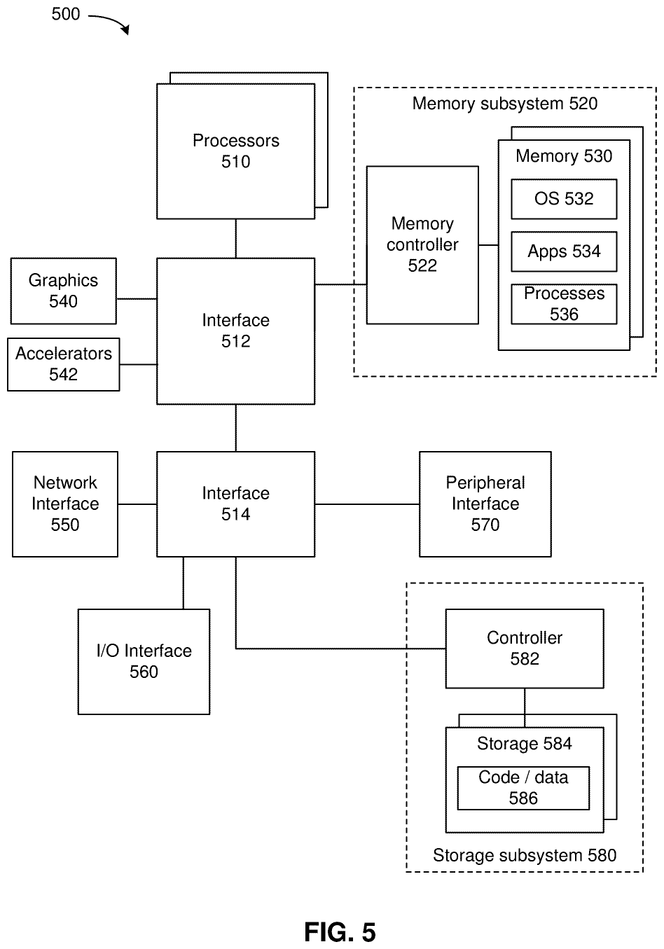

FIG. 1 depicts an example system. Host 100 can include one or more processors 110, memory 140, and other circuitry and software described at least with respect to FIGS. 3 and 5. Processors 110 can execute at least one or more of: operating system (OS) 112, processes 114, middleware 116, driver 118, and other software. Processes 114 can include one or more of: an application, process, thread, a virtual machine (VM), microVM, container, microservice, virtual function (VF), virtual device, or other virtualized execution environment. Processes 114 can provide requests via queues 142 to one or more devices 150-0 to 150-N to perform at least cryptographic, compression, and/or decompression operations on data 144. Driver 118 can provide a communication interface between OS 112 and one or more devices 150-0 to 150-N, where N is an integer.

Middleware 116 can provide an interface from processes 114 to driver 118 and allocate requests (e.g., calls to an application programming interface (API)) to queues 142 for inputting the requests for performance by a device of devices 150-0 to 150-N. Middleware 116 can selectively perform rate limiting of requests provided to one or more of devices 150-0 to 150-N based on a trained AI model. Middleware 116 can adjust allocation of requests among queues 142, shuffle requests among queues 142, and/or adjust a number of requests that can be allocated to one or more of queues 142 based on utilization of the device and a trained AI model. The AI model can determine a queue size and/or device resource allocation to meet or exceed latency goals in accordance with applicable service level agreement (SLA) parameters. The AI model can be trained based on impact of queue allocations to device latency or service level agreement (SLA) violations. The AI model can be trained based on at least one or more of: device congestion, device latency, device interface or network throughput, queue length, queue priority, request receipt rate, number of queues allocated to receive the requests, device memory usage, and/or address translation prefetch modes. Adjusting allocation of requests among the queues can include reducing a bandwidth limit allocated to a first queue of the queues and increasing a bandwidth limit allocated to a second queue of the queues. Device resource allocation can include at least some of: device interface throughput, network throughput, memory allocation, cache allocation, operating frequency, operating power, or others. Various examples can reduce underutilization of resources of one or more of devices 150-0 to 150-N.

In some examples, middleware 116 can adjust a queue size by adjusting a number of tokens allocated to the queue. A bucket can be associated with a queue and tokens assigned to the bucket can control a size of data that can be allocated to the queue. For example, for a traffic type of text, a token allocation can allocate a bucket size of X bits per cycle. For example, for a traffic type of video, a token allocation can allocate a bucket size of Y bits per cycle. For example, for a traffic type of voice, a token allocation can allocate a bucket size of Z bits per cycle. Values of X, Y, and Z can depend on a priority of the traffic type. For example, Z>Y>X, where voice has a highest priority request rate for processing by a device, video has a second highest priority, and text has a lowest priority among those traffic types. Middleware 116 can increase or decrease a bucket size of a queue to control a rate of performance of requests, as described herein.

Queues 142 can be allocated in memory 140 and store requests associated with data 144 to be processed by one or more of devices 150-0 to 150-N. In some examples, different queues of queues 142 can be associated with different priority levels, different data types, or Single Root I/O Virtualization (SR-IOV) virtual functions (VFs) or Scalable I/O Virtualization (SIOV) Assignable Device Interfaces (ADIs). In some examples, data types can include text, voice, or video.

One or more of devices 150-0 to 150-N can be accessible as VFs or ADIs. One or more of devices 150-0 to 150-N can include one or more: accelerator, graphics processing unit (GPU), storage device, network interface device, or other circuitry. For example, an accelerator can perform cryptographic, compression, or decompression operations on data. An example accelerator includes Intel® QuickAssist Technology (QAT). An example QAT is described at least with respect to FIG. 3. One or more of devices 150-0 to 150-N can include accelerator cores, which can be organized into slices. A slice can include a logical partition of accelerator core and a slice can be configured to handle specific types of workloads, such as cryptographic operations (e.g., encryption, decryption) or data compression. QAT can perform offloaded compression and decompression of data by applying one of multiple different compression formats (e.g., Zstandard, DEFLATE, or others).

In addition to rate limiting by middleware 116, one or more of devices 150-0 to 150-N can perform rate limiting to limit receipt of requests in queues 142 to satisfy service level agreement (SLA) parameters for a submitter process 114. For example, one or more of devices 150-0 to 150-N can monitor resource utilization by different processes 114 and limit utilization based on applicable SLA configurations. Rate limiting can be based on token buckets where tokens are added to a bucket at a fixed rate, and an incoming request consumes one token. If a token is available, the request is processed, and a token is removed; if the bucket is empty, the request is rejected until more tokens are refilled.

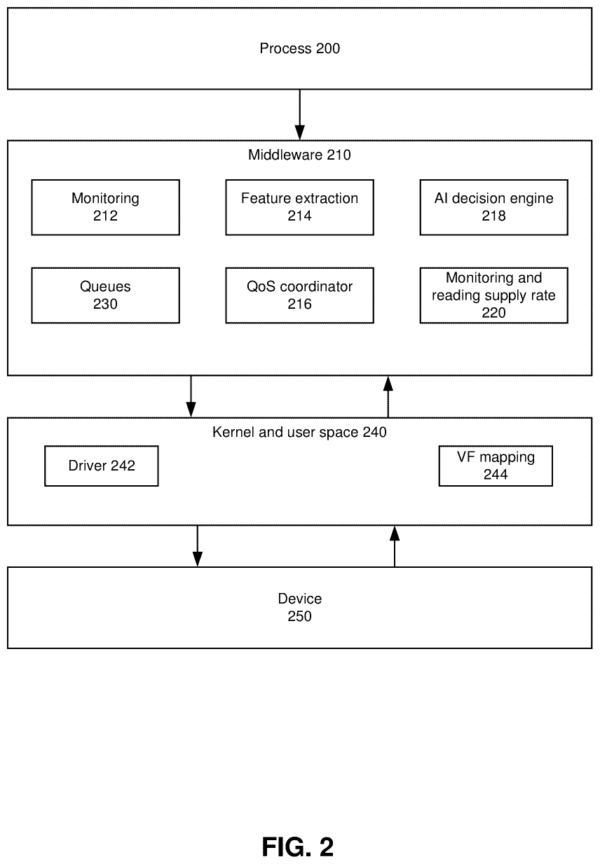

FIG. 2 depicts an example system. Process 200 can issue requests to perform operations to device 250. Device 250 can include one or more of: accelerator, graphics processing unit (GPU), storage device, network interface device, or other circuitry. In some examples, device 250 can perform at least cryptographic or compression services to offload intensive workloads.

Middleware 210 can allocate requests to queues 230 for inputting the requests for performance by device 250 by adjusting allocation of requests among the queues based on utilization of the device and an artificial intelligence (AI) model trained on at least one or more of: device congestion, device latency, device interface or network throughput, queue length, queue priority, request receipt rate, number of queues allocated to receive the requests, device memory usage, and/or address translation prefetch modes.

Queues 230 can isolate traffic based on service type to prevent contention among different service types. A queue of queues 230 can be assigned to one or more VFs or ADIs, traffic types, or quality of service. In some examples, queues 230 can include virtual queues that reference queues in host memory (e.g., memory 140).

Middleware 210 can perform monitoring of device utilization 212 by calculating a number of input requests to device 250 at intervals of period T, while a token update process is active. Monitoring of device utilization 212 can collect metrics from device 250 such as request rate, number of queues per services, memory usage, or others. Monitoring of device utilization 212 can measure depth of queues 230 and processing latency of requests by device 250. Middleware 210 can perform feature extraction 214 to determine a throughput of device 250 in a time window for reference and calculate output per queue.

Middleware 210 can perform quality of service (QoS) coordinator 216 to allocate resources to queues and attempt SLA compliance through dynamic queue management and traffic isolation. QoS coordinator 216 can track SLA usage per VF or ADI and redistribute loads or adjust queue weights based on feedback from AI decision engine 218.

Middleware 210 can perform monitoring and reading supply rate 220 to read token supply rate to a queue over a defined interval (T) and provide feedback to AI decision engine 218 to indicate available tokens for use with requests. In some examples, tokens can write-accessible by a physical function (PF) agent and read-accessible by AI engine 218.

Middleware 210 can perform AI decision engine 218 to determine a rate of token allocation to queues to fulfill requests. AI decision engine 218 can monitor effect of token disbursal adjustments (e.g., increase or decrease) and queue rebalancing on latency and SLA compliance. Based on a device having increased latency or SLA violation for a first process, AI decision engine 218 can increase a rate of token disbursement to a first queue or the first process to increase a rate of performance of requests and decrease a rate of token disbursement to one or more other queues or processes to decrease a rate of performance. The engine applies reinforcement learning for rate limiting and resource allocation. For example, middleware 210 can increase a bucket size for high-throughput, low-latency traffic, decrease a bucket size for congested or sensitive traffic, and/or apply updated bucket size to traffic shaping or policing.

Kernel or user space 240 can include drivers 242 for device 250. VF mappings 244 can identify VFs allocated to queues and manage VF mappings to a physical function (PF) for device 250 to resources of device 250 (e.g., memory, slice, or others) using ioctl or sysfs.

The following is an example operation of training and inference performed by middleware 210. In a first operation, monitoring of requests can be performed. For example, monitoring of requests can include determination of inter-arrival time (e.g., time between request), job size (e.g., number of bytes of data to be processed or expected time to completion), and temporal features (e.g., time of day, day of the year, seasonality indicators, or others).

In a second operation, traffic type and priority can be determined as training data to train an AI model of AI decision engine 218. For example, traffic type can include text, audio, video, data, or others. A priority for traffic type can be configured. For example, voice can be assigned a higher priority than video and video assigned a higher priority than text. For inputs to an AI model, inputs can be converted into numerical vectors or structured formats and irrelevant or duplicate information can be removed. Inputs to the AI model can include at least some of: queue size, processed data size of requests, permitted latency in accordance with the SLA, device congestion, device latency, device interface or network throughput, queue length, queue priority, request receipt rate, number of queues allocated to receive the requests, device memory usage, address translation prefetch mode being enabled or disabled, and/or others.

In a third operation, a status of the accelerator device can be read. Device status can include at least: peak supply rate, committed supply rate, queue depth, utilization, or others. In a fourth operation, device latency can be measured. For example, device interface or network bandwidth can be measured such as latency of communication from a memory through a device interface or network to the device, latency of communication from the device through a device interface or network to a memory, or others.

In a fifth operation, a device burst request processing duration can be estimated for a queue. A burst duration can be calculated based on a number of tokens available to the queue and expected token consumption (e.g., a difference between a peak rate of token consumption and average rate of token consumption). In a sixth operation, prediction of likelihood of device congestion occurrence can occur. For example, if device latency is increasing and device throughput is decreasing, device congestion can be predicted to occur. For example, if device latency is decreasing and device throughput is increasing, device congestion can be predicted to not occur.

In a seventh operation, a bucket size can be adjusted for the queue based on device throughput and communication latency. For example, the bucket size can be increased to increase a number of tokens available to a queue and to potentially avoid overflow or request drops and achieve QoS goals based on a burst duration indicating that the tokens are expected to be exhausted before the burst duration is to end. For example, the bucket size can be decreased or maintained to decrease a number of tokens available to a queue based on a burst duration indicating that the tokens are not expected to be exhausted before the burst duration is to end.

FIG. 3 depicts an example accelerator. Accelerator 300 can utilize compressor 302 to compress clear text data into a format specified by configuration circuitry 312 or perform data decompression 304 on data in a format specified by configuration circuitry 312 to clear text. Various examples of compression and decompression standards include at least Lempel Ziv (LZ) family of compression schemes including LZ77, LZ78, LZ4, Zstandard (ZSTD), DEFLATE, GZIP, XP10, and Snappy standards. To compress data, compressor 302 can store a dictionary into history buffer 310 to identify strings of characters to replace in data. Integrity value generator 314 can generate a security code on a dictionary, input data, and/or output data. A security code can include a cyclic redundancy check (CRC), hash calculation, or checksum. Accelerator 300 can utilize encryption 306 to encrypt cleartext or compressed data based on a specification in configuration 312. Accelerator 300 can utilize decryption 308 to decrypt data based on a specification in configuration 312.

Configuration 312 can specify a standard of data encryption/decryption, including at least Triple Data Encryption Standard (3DES), Advanced Encryption Standard (AES), Digital Signature Algorithm (DSA), Rivest-Shamir-Adleman (RSA) algorithm, Elliptic Curve Digital Signature Algorithm (ECDSA), Elliptic Curve Cryptography (ECC), or others. Integrity value generator 314 can generate security codes (e.g., checksum, CRC values, or others) on cleartext or compressed data. Direct memory access (DMA) engines 316 can access data from memory (e.g., memory 140) and copy data into input buffer 318 based on a command from a process or copy data from output buffer 320 to memory (e.g., memory 140). Input buffer 318 can store data that is to be compressed, decompressed, encrypted, or decrypted. Output buffer 320 can store data that was compressed, decompressed, encrypted, or decrypted.

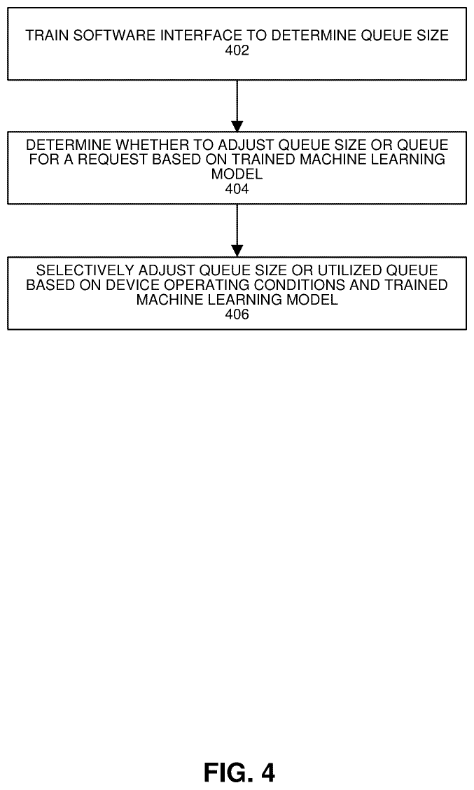

FIG. 4 depicts an example process. The process can be performed by an interface between a process and an accelerator driver and/or a hardware accelerator that can perform data compression, data decompression, data encryption, and/or data decryption. At 402, a machine learning (ML) model of a software interface between an accelerator device driver and a process can be trained to determine a size of a queue to the accelerator device. The queue can be allocated to operations submitted by a process to the device. Different queues can be associated with different priority levels, different data types, different VFs or ADIs, or others. In some examples, the training data can include past data of at least some of: queue size, processed data size of requests, permitted latency in accordance with the SLA, device congestion, device latency, device interface or network throughput, queue length, queue priority, request receipt rate, number of queues allocated to receive the requests, device memory usage, address translation prefetch mode being enabled or disabled, and/or others.

At 404, the software interface can determine an allocation of requests that are permitted to be fulfilled for a time period for the queue based on the ML model. For example, the ML model can determine whether to increase or decrease a number of tokens to a queue, where tokens allocated to the queue are utilized to limit a number of requests that are performed. For example, the ML model can determine to migrate requests to a different queue. At 406, based on a decision to modify an allocation of requests to a queue, the software interface can adjust the number of requests that can allocated to a queue or allocate the request to a different queue.

FIG. 5 depicts a system. The system can use examples described herein to adjust a rate of request submissions to a device (e.g., processor 510, graphics 540, one or more of accelerators 542, and/or network interface 550) by adjusting queue size or selecting a different queue. In some examples, a device can perform rate limiting of performance of requests as well. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die.

Accelerators 542 can be a fixed function or programmable offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 542 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as static random-access memory (SRAM), dynamic random-access memory (DRAM), or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. In some examples, network interface 550 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory.

Some examples of network interface 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 550 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. A non-volatile memory (NVM) device is a memory whose state is determinate even if power is interrupted to the device.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples and includes at least one non-transitory computer-readable medium comprising instructions stored thereon, that if executed by one or more processors, cause the one or more processors to: allocate requests to queues for inputting the requests to a device to perform the requests by: adjusting a queue size based on utilization of the device and an artificial intelligence (AI) model trained on at least one or more of: data size, request priority, device congestion, device latency, device interface throughput, network throughput, queue length, queue priority, request receipt rate, number of queues allocated to receive the requests, device memory usage, and/or whether address translation prefetch mode is enabled or not enabled, wherein: the device comprises an accelerator to perform cryptographic and/or compression operations in response to the requests.

Example 2 includes one or more earlier or later examples, wherein the adjusting the queue size comprises increasing an amount of data permitted to be processed and/or changing a queue allocated to perform the requests.

Example 3 includes one or more earlier or later examples, wherein the AI model is trained based on impact of queue sizes to device latency or service level agreement (SLA) violations.

Example 4 includes one or more earlier or later examples, wherein an interface from a process to a driver for the device performs the allocate requests to queues for inputting the requests to a device to perform the requests.

Example 5 includes one or more earlier or later examples, wherein the queues are associated with respective priority levels.

Example 6 includes one or more earlier or later examples, wherein the queues are associated with different data types and wherein the data types comprise at least: text, voice, or video.

Example 7 includes one or more earlier or later examples, wherein the queues are allocated to respective virtual functions (VFs) for accessing the device.

Example 8 includes one or more earlier or later examples, and includes an apparatus that includes: an accelerator to perform cryptographic and/or compression operations in response to requests and a circuitry, coupled to the accelerator, to: allocate requests to queues for inputting the requests for performance by the accelerator by: adjustment of characteristics of a queue allocated to perform the requests based on utilization of the accelerator and an artificial intelligence (AI) model trained on at least one or more of: data size, request priority, device congestion, device latency, device interface throughput, network throughput, queue length, queue priority, request receipt rate, number of queues allocated to receive the requests, device memory usage, and/or whether address translation prefetch mode is enabled or not enabled.

Example 9 includes one or more earlier or later examples, wherein the adjustment of characteristics of the queue allocated to perform the requests comprises adjust an amount of data permitted to be processed and/or change a queue allocated to perform the requests.

Example 10 includes one or more earlier or later examples, wherein the AI model is trained based on impact of queue characteristics to device latency or service level agreement (SLA) violations.

Example 11 includes one or more earlier or later examples, wherein an interface from a process to a driver for the accelerator performs the adjustment of characteristics of the queue allocated to perform the requests.

Example 12 includes one or more earlier or later examples, wherein the queues are associated with respective priority levels.

Example 13 includes one or more earlier or later examples, wherein the queues are associated with different data types and wherein the data types comprise at least: text, voice, or video.

Example 14 includes one or more earlier or later examples, wherein the queues are allocated to respective virtual functions (VFs) for accessing the accelerator.

Example 15 includes one or more earlier or later examples, and includes a method that includes a processor-executed software interface between a process and device driver performing: adjusting characteristics of a queue allocated to perform requests to the device based on utilization of the device and an artificial intelligence (AI) model trained on at least one or more of: data size, request priority, device congestion, device latency, device interface throughput, network throughput, queue length, queue priority, request receipt rate, number of queues allocated to receive the requests, device memory usage, and/or whether address translation prefetch mode is enabled or not enabled, wherein: the device comprises an accelerator to perform cryptographic and/or compression operations in response to the requests.

Example 16 includes one or more earlier or later examples, wherein the adjusting characteristics of a queue allocated to perform requests to the device comprises adjusting an amount of data permitted to be processed and/or changing a queue allocated to perform the requests

Example 17 includes one or more earlier or later examples, wherein the AI model is trained based on impact of queue characteristics on device latency or service level agreement (SLA) violations.

Example 18 includes one or more earlier or later examples, wherein the queues are associated with respective priority levels.

Example 19 includes one or more earlier or later examples, wherein the queues are associated with different data types and wherein the data types comprise at least: text, voice, or video.

Example 20 includes one or more earlier or later examples, wherein the queues are allocated to respective virtual functions (VFs) for accessing the accelerator.

1. At least one non-transitory computer-readable medium comprising instructions stored thereon, that if executed by one or more processors, cause the one or more processors to:
allocate requests to queues for inputting the requests to a device to perform the requests by:
adjusting a queue size based on utilization of the device and an artificial intelligence (AI) model trained on at least one or more of: data size, request priority, device congestion, device latency, device interface throughput, network throughput, queue length, queue priority, request receipt rate, number of queues allocated to receive the requests, device memory usage, and/or whether address translation prefetch mode is enabled or not enabled, wherein:
the device comprises an accelerator to perform cryptographic and/or compression operations in response to the requests.

2. The at least one computer-readable medium of claim 1, wherein the adjusting the queue size comprises increasing an amount of data permitted to be processed and/or changing a queue allocated to perform the requests.

3. The at least one computer-readable medium of claim 1, wherein the AI model is trained based on impact of queue sizes to device latency or service level agreement (SLA) violations.

4. The at least one computer-readable medium of claim 1, wherein an interface from a process to a driver for the device performs the allocate requests to queues for inputting the requests to a device to perform the requests.

5. The at least one computer-readable medium of claim 1, wherein the queues are associated with respective priority levels.

6. The at least one computer-readable medium of claim 1, wherein the queues are associated with different data types and wherein the data types comprise at least: text, voice, or video.

7. The at least one computer-readable medium of claim 1, wherein the queues are allocated to respective virtual functions (VFs) for accessing the device.

8. An apparatus comprising:
an accelerator to perform cryptographic and/or compression operations in response to requests and
a circuitry, coupled to the accelerator, to:
allocate requests to queues for inputting the requests for performance by the accelerator by:
adjustment of characteristics of a queue allocated to perform the requests based on utilization of the accelerator and an artificial intelligence (AI) model trained on at least one or more of: data size, request priority, device congestion, device latency, device interface throughput, network throughput, queue length, queue priority, request receipt rate, number of queues allocated to receive the requests, device memory usage, and/or whether address translation prefetch mode is enabled or not enabled.

9. The apparatus of claim 8, wherein the adjustment of characteristics of the queue allocated to perform the requests comprises adjust an amount of data permitted to be processed and/or change a queue allocated to perform the requests.

10. The apparatus of claim 8, wherein the AI model is trained based on impact of queue characteristics to device latency or service level agreement (SLA) violations.

11. The apparatus of claim 8, wherein an interface from a process to a driver for the accelerator performs the adjustment of characteristics of the queue allocated to perform the requests.

12. The apparatus of claim 8, wherein the queues are associated with respective priority levels.

13. The apparatus of claim 8, wherein the queues are associated with different data types and wherein the data types comprise at least: text, voice, or video.

14. The apparatus of claim 8, wherein the queues are allocated to respective virtual functions (VFs) for accessing the accelerator.

15. A method comprising:
a processor-executed software interface between a process and device driver performing:
adjusting characteristics of a queue allocated to perform requests to the device based on utilization of the device and an artificial intelligence (AI) model trained on at least one or more of: data size, request priority, device congestion, device latency, device interface throughput, network throughput, queue length, queue priority, request receipt rate, number of queues allocated to receive the requests, device memory usage, and/or whether address translation prefetch mode is enabled or not enabled, wherein:
the device comprises an accelerator to perform cryptographic and/or compression operations in response to the requests.

16. The method of claim 15, wherein the adjusting characteristics of a queue allocated to perform requests to the device comprises adjusting an amount of data permitted to be processed and/or changing a queue allocated to perform the requests.

17. The method of claim 15, wherein the AI model is trained based on impact of queue characteristics on device latency or service level agreement (SLA) violations.

18. The method of claim 15, wherein the queues are associated with respective priority levels.

19. The method of claim 15, wherein the queues are associated with different data types and wherein the data types comprise at least: text, voice, or video.

20. The method of claim 15, wherein the queues are allocated to respective virtual functions (VFs) for accessing the accelerator.
